(19) United States
(12) Patent Application Publication
(10) Pub. No.: US 2003/0024692 A1
(43) Pub. Date: Feb. 6, 2003

(54) High efficiency heat exchanger

(76) Inventor: Ho-Hsin Wu, I-Lan (TW)

Correspondence Address: DOUGHERTY & TROXELL, SUITE 1404, 5205 LEESBURG PIKE, FALLS CHURCH, VA, 22041, US

(21) Appl. No.: 09/983,864

(22) Filed: Oct. 26, 2001

(30) Foreign Application Priority Data
Aug. 2, 2001 (TW) 090118869

(51) Int. Cl. F28D 1/00; A23C 3/04

(52) U.S. Cl. 165/115; 165/911

(57) ABSTRACT

A heat exchanger for a medium condenser mainly comprises a plurality of vertical cooling fins essentially having extra length extended both upwardly and downwardly from an ordinary portion of medium coil path for greatly increase the cooling efficiency therefore, and a drip-drop type water feeding box for feeding water drops to a top of cooling fins densely but intermittently to let each of water drop been held in the spacing between opposite surfaces of adjacent cooling fins a short period of time and start to slide down around the surface of a cooling fin as a next drop of water is delivered to provide enough time for evaporating so as to absorb a large quantity of latent heat for increasing cooling efficiency therefore.

### FIELD OF THE INVENTION

The present invention relates to a heat exchanger for a medium condenser especially relates to a high efficiency heat exchanger in a combination of air cooling and water evaporating cooling system.

### BACKGROUND OF THE INVENTION

A conventional heat exchanger of a medium condenser is usually in an air cooling or a water cooling type.

Which an air cooling heat exchanger as shown in FIG. 1 comprises a plurality of vertical cooling fins, a plurality of medium pipes bored laterally through cooling fins and connected in series to a singly medium coil, however the efficiency of this type is not high enough for reducing critical pressure of medium condensing therefor a long medium coil piping should be used for maintaining a high pressure therein.

While a water cooling heat exchanger may obtains a little better cooling efficiency but a large place is needed for a water shower cooling tower and a long piping system, a large fan system are also needed, therefore the cost becomes much high, further more, a conventional water cooling system usually uses a plurality of water spray nozzles to spray water continuously onto the cooling fins under a pressure. Therefore an impact and splash will force the water flowed over the cooling fins quickly so that it can not provide an evaporating effect but water cooling only beside a large quantity of circulating water need a large collection pan and a powerful water pump for operating.

### SUMMARY OF THE INVENTION

The present invention has been recovered the aforesaid drawbacks, therefore.

A main object of the present invention is to provide a high efficiency heat exchanger having extra length cooling fins to increase air cooling efficiency.

Another main object is to provide a high efficiency heat exchanger by using a drip-drop type water feeding box to obtain a water evaporating effect therefore.

Also another main object is to provide a high efficiency heat exchanger which an extreme low temperature is reached in the system due to high cooling efficiency so that a plurality of medium coil sets connected in parallel can be applied to condense cooling medium in each medium coil set under a lower critical pressure.

Still another object is to provide a high efficiency heat exchanger having extra cooling zones to instead a cooling tower of a conventional water cooling system to cooling the circulated water for cost saving.

According to one aspect of the present invention, the high efficiency heat exchanger mainly comprising a plurality of vertical cooling fins essentially having extra length extended both upwardly and downwardly from an ordinary portion of medium coil path for greatly increase the cooling efficiency therefore, and a drip-drop type water feeding box for feeding water drops to a top of cooling fins densely but intermittently to let each of water drop been held in the spacing between opposite surfaces of adjacent cooling fins a short period of time and start to slide down around the surface of a cooling fin as a next drop of water is delivered to provide enough time for evaporating so as to absorb a large quantity of latent heat for increasing cooling efficiency therefore.

### BRIEF DESCRIPTION OF THE DRAWINGS

FIG. 1 shows a conventional air cooling heat exchanger.

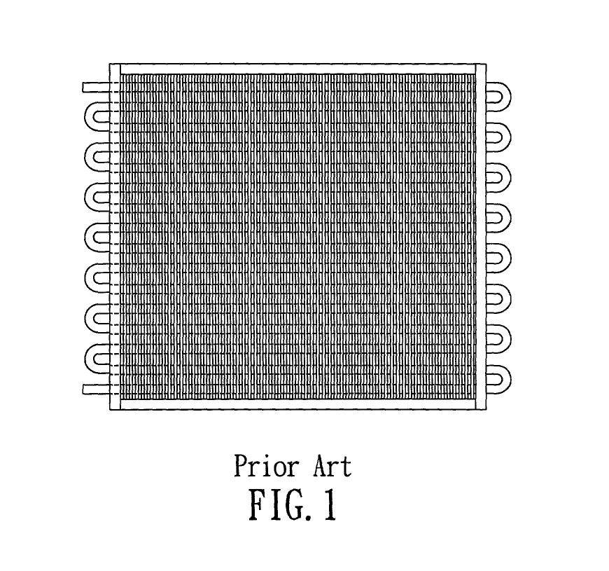

FIG. 2 showing extra cooling zones extended from an ordinary portion according to the present invention.

FIG. 3 is an explosive view of a drip-drop type water feeding box.

FIG. 4 shows medium coil sets according to the present invention.

FIG. 5 shows a water supply system of the present invention.

FIG. 6 shows a double row heat exchanger according to the present invention.

### DETAILED DESCRIPTION OF THE PREFERRED EMBODIMENT

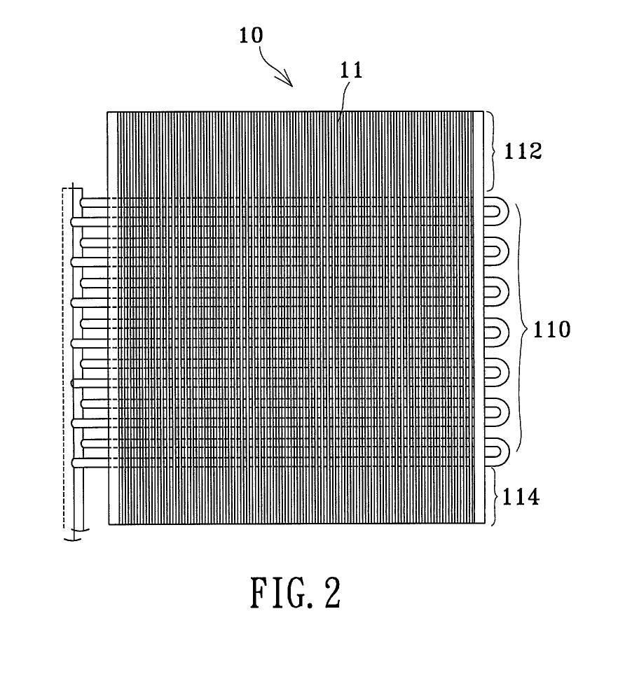

Please referring to FIG. 2, a heat exchanger 10 according to the present invention comprises a plurality of vertical cooling fins 11 having an ordinary portion 110 of medium coil path and essentially having an upside additional cooling zone 112 and a downside additional cooling zone 114 bath formed by extra length of cooling fins 11 extended upwardly and downwardly from the ordinary portion 110 to increase the radiating surface thereof so as to greatly raise the cooling efficiency therefore.

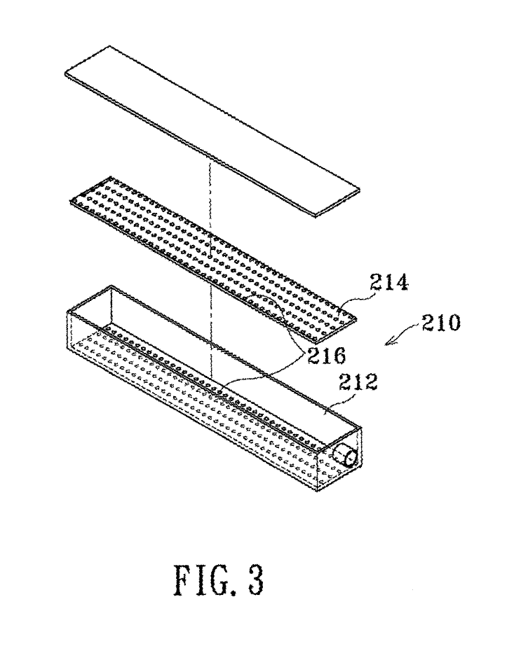

Referring to FIG. 3, an evaporative water feeding box 210 of drop-drip type comprises a bottom plate 212 having a plurality of small seeping holes 216 densely disposed to the bottom plate, and at least one layer 214 of horizontal partition plate also having small seeping holes 216 thereat to depart at least one upper section and one lower section therefore, as the water is circulated into the feeding box 210 from a top into the upper section it will be seeped into the lower section from each seeping holes 216 drop by drop, and then it will be seeped to a top of cooling fins also drop from each seeping holes gently without impact and splash.

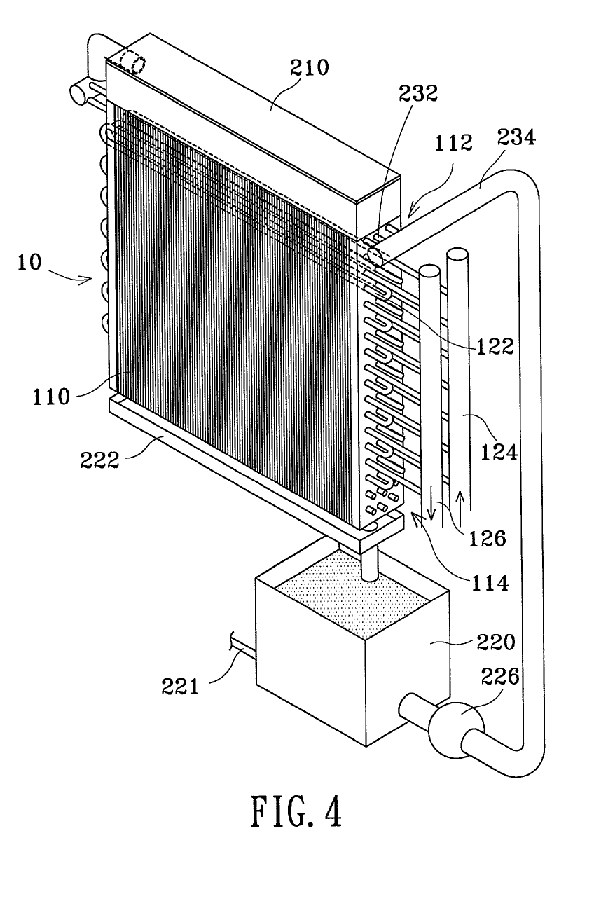

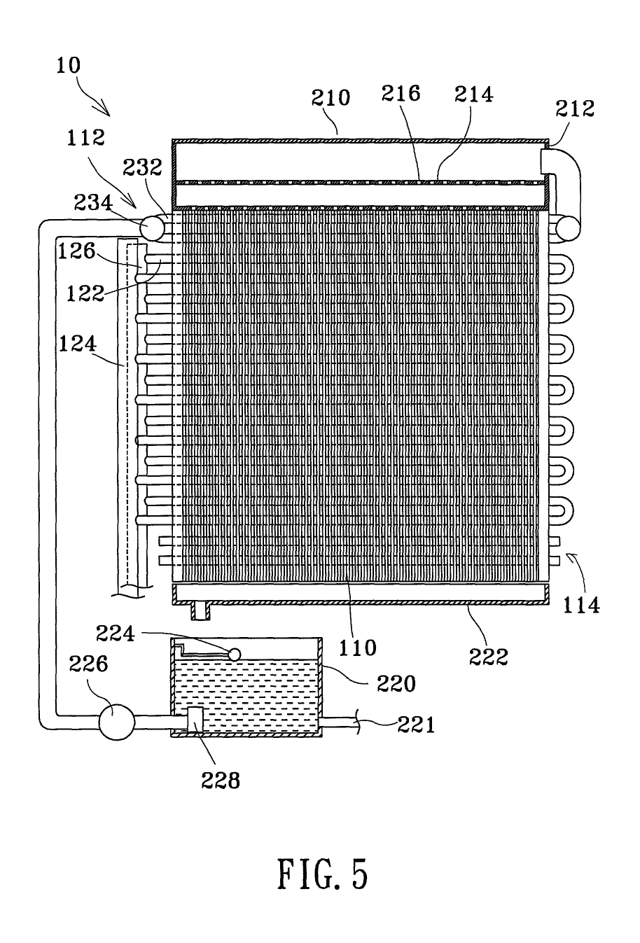

Referring to FIGS. 4 and 5, there shows a medium intake manifold 124 receiving the pressurized vapor state medium from a medium compressor (not show) and distributed the vapor state medium into each set of medium coil 122 in parallel, in which the medium is condensed to liquid state and collected by an outlet manifold 126 then guided into an evaporator (not show) through an expansion valve (not show); and a water circulating supply system comprising a water reservoir 220 having a sewage blow-down pipe 221 disposed at a side near to a bottom, a filter 228 (FIG. 5) disposed to a bottom ahead of a pump 226, and a floating balloon valve 224 (FIG. 5) connected to a city water piping to replenish water automatically while the water level in the reservoir 220 going down to a predetermined low position due to a consumption of evaporating, the pump 226 is a speed adjustable pump connected between filter 228, water pipe 234 and a water coil 232 for setting a selective speed to supply a adequate quantity of water almost equal to the consumption water evaporated, the water coil 232 disposed at the upside additional cooling zone 112 laterally bored through the cooling fins for cooling the water before using a residual water collecting channel 222 disposed under the downside additional cooling zone 114 to collect residual water therein and guided residual water back to the reservoir, while the residual water pass dropped pass through the downside addition cooling zone 114 it will be cooled to a low temperature to insure there will be no temperature raising even during a long term running, and a fan system (not shown) for blow off the heat and evaporated moisture away therefor.

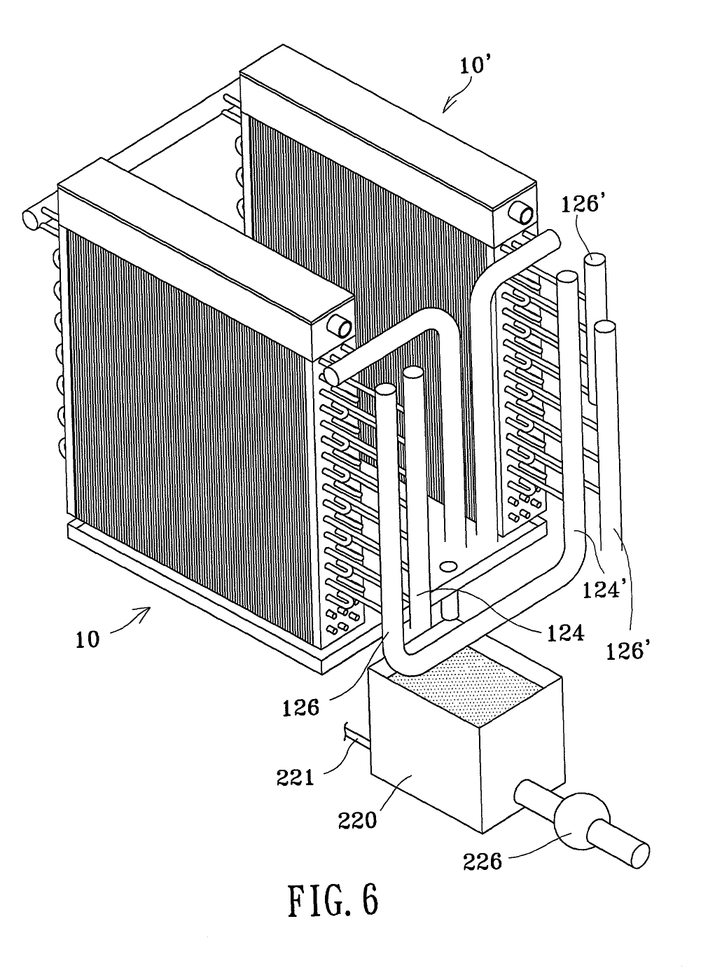

Referring to FIG. 6, there shows a topical embodiment of a double row heat exchanger of the present invention comprising a first row heat exchanger 10 and a second heat exchanger 10′ which a medium intake manifold 124 distribute the pressurized vapor state medium into a plurality of parallel connected coil sets from a medium compressor (not shown) for a first step condensing in the first row heat exchanger 10 and then guided the medium in to another intake manifold 124′ of second row heat exchanger 10′ from an outlet manifold 126 of first row heat exchanger 10 for a second step condensing in the second row heat exchanger 10′ and then collect the liquids state medium to an outlet manifold 126′ for guiding to the medium evaporator (not shown) through an expansion valve (not shown) therefore.

It is to be understood that the drawings are designed for purposes of illustration only, and are not intended as a definition of the limits and scope of the invention disclosed.

What the invention claimed is:

1. A high efficiency heat exchanger for a medium condenser comprising:
a plurality of paralleled vertical cooling fins arranged in even spacing and essentially having extra length extended both upwardly and downwardly form an ordinary portion of said cooling fins formed an upside additional cooling zone and a downside additional cooling zone therefore;
a plurality of medium coil sets connected in parallel laterally bored through said ordinary portion of said cooling fins instead of a conventional single coil which connects all pipes in series;
a drip-drop type water feeding box of an evaporative water supply system disposed at a top closely over said cooling fins for feeding water densely drop by drop onto a top edge of said cooling fins; and
a fan system to deliver wind passing though said spacing between said cooling fins for speeding the evaporation of evaporative water and blowing off heat and evaporated steam away therefore.

2. A high efficiency heat exchanger according to claim 1, wherein said medium coil sets are connected in parallel form a medium intake manifold for evenly distributing pressurized vapor state medium form a medium compressor to each medium coil set there into.

3. A high efficiency heat exchanger according to claim 1, wherein said medium coil sets are connect to an outlet manifold for collection liquid state medium condensed in each coil set and guiding liquid state medium into an evaporator through an expansion valve.

4. A high efficiency heat exchanger according to claim 1, wherein said drip-drop type water feeding box of an evaporative water supply system having a plurality of small seeping holes disposed at a bottom plate densely for feeding water drops therefrom.

5. A high efficiency heat exchanger according to claim 4, wherein said water feeding box further consisting at least one layer of horizontal partition plate to depart at least one upper section and one lower section and also having a plurality of small seeping holes thereat for feeding water drops from said upper section to said lower section.

6. A high efficiency heat exchanger according to claim 1, wherein said evaporative water supply system further comprises: a residual water collecting channel, a water reservoir, a water pump, and a water coil thereof.

7. A high efficiency heat exchanger according to claim 6, wherein said water collecting channel is disposed under a bottom of said downside additional cooling zone of said cooling fins for collecting residual water and fed back to said water reservoir, in which the residual water is cooled to a low temperature during at passed through said downside additional cooling zone before dropped into said water collecting channel.

8. A high efficiency heat exchanger according to claim 6, wherein said water reservoir consists of a floating balloon valve connected to a city water piping for automatically refilling water run a predetermined low level due to consumption of evaporating to a predetermined high level therein.

9. A high efficiency heat exchanger according to claim 6, wherein said water pump is a speed adjustable water pump which connected between said water reservoir and said water coil for controlling water supplied to said evaporative water feeding box through said water coil from said water reservoir in a selected quantity almost equal to the consumption of water evaporated.

10. A high efficiency heat exchanger according to claim 6, wherein said water coil is disposed to pierce through said upside additional cooling zone of said cooling fins for cooling evaporative water before guided to said feeding box.

11. A high efficiency heat exchanger for a medium condenser of refrigerating apparatus or air conditioning apparatus comprises:
an upside additional cooling zone and a downside additional cooling zone for increasing cooling efficiency therefore;
an evaporative water supply system to feed water drops intermittently to said cooling fins in a no compact and no splash condition to let the water remaining to the surfaces of said cooling fins for maintaining enough time to be almost fully evaporated, there fore a large quantity of latent heat be absorbed form medium for greatly increasing cooling efficiency there fore.

12. A high efficiency heat exchanger according to claim 11, wherein which said upside additional cooling zone is utilized for cooling evaporative water before heat exchanging, while said downside additional cooling zone is utilized for cooling residual water after heat exchanging therefore to insure that there will be no temperature raising even during a long term running.
